(19) United States
(12) Patent Application Publication
(10) Pub. No.: US 2012/0012715 A1
(43) Pub. Date: Jan. 19, 2012

(54) SYSTEMS, METHODS, AND APPARATUS FOR PROVIDING A METAL CLAD CABLE CLAMP

(75) Inventors: Ryan M. Andersen, Williamsport, PA (US); Tom Hirschle, Williamsport, GA (US)

(73) Assignee: ALCAN PRODUCTS CORPORATION, Atlanta, GA (US)

(21) Appl. No.: 12/835,270

(22) Filed: Jul. 13, 2010

(51) Int. Cl. F16L 3/10; B23P 19/04

(52) U.S. Cl. 248/74.1; 29/428

(57) ABSTRACT

Embodiments of the invention relate to systems, methods, and apparatus for providing a metal clad cable clamp. In one embodiment, an apparatus or clamp for mounting a cable to a strut can be provided. The clamp can include a clamp body operable to mount to the strut, wherein a portion of the cable is positioned between the clamp body and the strut. The clamp can also include at least one adjustment device operable to force a portion of the clamp body against the portion of the cable, wherein the portion of the cable is maintained substantially adjacent to the strut.

### TECHNICAL FIELD

The invention relates generally to cable clamps, and more particularly to systems, methods, and apparatus for providing a metal clad cable clamp.

### BACKGROUND OF THE INVENTION

Metal clad cable or “MC cable” is generally designed to house one or more electrical conductors within a relatively larger flexible metal tube or casing. The flexible metal tube or casing can be formed from a relatively durable metal, such as aluminum or an alloy, to protect the electrical conductors housed within the tube or casing. Depending on the construction and materials forming the tube or casing, MC cable can be used in a variety of outdoor, indoor, above ground, below ground, or other specific applications.

In certain applications, a MC cable can be installed in a relatively vertical orientation, such as an installation against a tower or other relatively tall structure. In these instances, the MC cable can be mounted against the tower or tall structure. However, conventional mountings can permit internal components of MC cable to slip or otherwise move vertically with respect to the mounting. Slippage or movement of the MC cable internal components with respect to the tower or tall structure can require relatively expensive and time consuming repair or re-installation.

### SUMMARY OF THE INVENTION

Embodiments of the invention can provide some or all of the above needs. Certain embodiments of the invention can provide systems, methods, and apparatus for providing a metal clad cable clamp. In one embodiment, an apparatus or clamp for mounting a cable to a strut can be provided. The clamp can include a clamp body operable to mount to the strut, wherein a portion of the cable is positioned between the clamp body and the strut. The clamp can also include at least one adjustment device operable to force a portion of the clamp body against the portion of the cable, wherein the portion of the cable is maintained substantially adjacent to the strut.

In one aspect of an embodiment, the clamp substantially resists cable movement when a pullout force is applied to the cable.

In one aspect of an embodiment, the clamp body can include a first clamp body portion, a second clamp body portion, wherein the first clamp portion and second clamp body portion interlock with each other, and a saddle portion positioned between the first clamp body portion and the second clamp body portion, wherein the saddle portion is manipulated by the at least one adjustment device.

In one aspect of an embodiment, the at least one adjustment device can include at least one of the following: a bolt, a pair of bolts, or a spring.

In one aspect of an embodiment, an external portion of the clamp body is operable to conform with the portion of the cable.

In one aspect of an embodiment, the clamp body maintains the cable in a relatively vertical orientation with respect to the strut.

In one aspect of an embodiment, the first clamp body portion or the second clamp body portion is operable to engage a portion of the strut to maintain the position of the clamp body with respect to the universal strut.

In one aspect of an embodiment, the saddle portion comprises a plurality of plates operable to contact the portion of the cable.

In another embodiment, a method for mounting a cable to a strut can be provided. The method can include providing a clamp body and at least one adjustment device, mounting the clamp body to the strut, wherein a portion of the cable is positioned between the clamp body and the strut, and manipulating the at least one adjustment device to force a portion of the clamp body against the portion of the cable, wherein the portion of the cable is maintained substantially adjacent to the strut.

In one aspect of an embodiment, the clamp body can include a first clamp body portion, a second clamp body portion, wherein the first clamp portion and second clamp body portion interlock with each other, and a saddle portion positioned between the first clamp portion and second clamp portion, wherein the saddle portion is manipulated by the at least one adjustment device.

In one aspect of an embodiment, the at least one adjustment device can include at least one of the following: a bolt, a pair of bolts, or a spring.

In one aspect of an embodiment, the external portion of the clamp body is operable to conform with the portion of the cable.

In one aspect of an embodiment, the clamp body maintains the cable in a relatively vertical orientation with respect to the strut.

In one aspect of an embodiment, the first clamp body portion or the second clamp body portion is operable to engage a portion of the strut to maintain the position of the clamp body with respect to the strut.

In another embodiment, a system for mounting a cable to a strut can be provided. The system can include a first clamp body portion, a second clamp body portion, wherein the first clamp portion and second clamp body portion interlock with each other defining a clamp body operable to mount to the strut, wherein a portion of the cable is positioned between the clamp body and the strut, and a saddle portion mounted between the first clamp body portion and the second clamp body portion, and at least one adjustment device operable to force the saddle portion against the portion of the cable, wherein the portion of the cable is maintained substantially adjacent to the strut between the saddle portion and the strut.

In one aspect of an embodiment, the clamp substantially resists cable movement when a pullout force is applied to the cable.

In one aspect of an embodiment, the at least one adjustment device can include at least one of the following: a bolt, a pair of bolts, or a spring.

In one aspect of an embodiment, an external portion of the saddle portion is operable to conform with the portion of the cable.

In one aspect of an embodiment, the clamp body maintains the cable in a relatively vertical orientation with respect to the universal strut.

In one aspect of an embodiment, the first clamp body portion or the second clamp body portion is operable to engage a portion of the strut to maintain the position of the clamp body with respect to the strut.

Other systems and processes according to various embodiments of the invention will become apparent with respect to the remainder of this document.

### BRIEF DESCRIPTION OF DRAWINGS

Having thus described embodiments of the invention in general terms, reference will now be made to the accompanying drawings, which are not drawn to scale, and wherein:

FIG. 1 illustrates an example system and apparatus according to one embodiment of the invention.

FIG. 2 illustrates an exploded view of the system and apparatus shown in FIG. 1.

FIG. 3 illustrates a front view of a system and apparatus shown in FIGS. 1 and 2.

FIG. 4 illustrates a perspective view of the system and apparatus shown in FIGS. 1-3.

FIGS. 5-7 illustrate perspective views of other example systems and apparatus according to certain embodiments of the invention.

FIGS. 8-10 illustrate perspective views of example clamp components for a system, apparatus, and clamp according to certain embodiments of the invention.

FIGS. 11-14 illustrate perspective views of example clamp components for a system, apparatus, and clamp according to certain embodiments of the invention.

FIG. 15 illustrates a flowchart of an example method according to one embodiment of the invention.

### DETAILED DESCRIPTION OF EMBODIMENTS OF THE INVENTION

Embodiments of the invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention. Like numbers refer to like elements throughout.

As used herein, the term “MC” refers to the phrase “metal clad.” For example, MC cable refers to a metal clad cable, and MC cable clamp refers to a clamp for a metal cable.

As used herein, the term “strut” can refer to an object for mounting a cable or other component object to. Examples of a suitable strut can be a structural support, a beam, a rod, a pipe, a board, or any geometrically shaped object suitable for mounting a relatively round or other shaped cable to.

Certain embodiments of the invention generally provide for systems, methods, and apparatus for providing a MC cable clamp. Because a MC cable can be held in a relatively stationary position against an object, such as a strut, using various systems, methods, apparatus, and clamps according to embodiments of the invention, such embodiments can result in decreased operating, maintenance, and repair costs. Furthermore, technical effects by certain embodiments of the invention can result such as the ability to position a MC cable in a substantially vertical orientation for relatively long periods of time. One technical result of certain embodiments of the invention is the ability to resist cable movement when relatively high pullout forces are applied to a MC cable to which embodiments of the invention may be applied. One should appreciate that certain embodiments of the invention can be used in other environments, contexts, and applications, and should not be limited to MC cable applications or applications in which a MC cable is in a substantially vertical orientation, but should include non-MC cable applications and applications in which a MC cable or non-MC cable is installed in a non-vertical orientation.

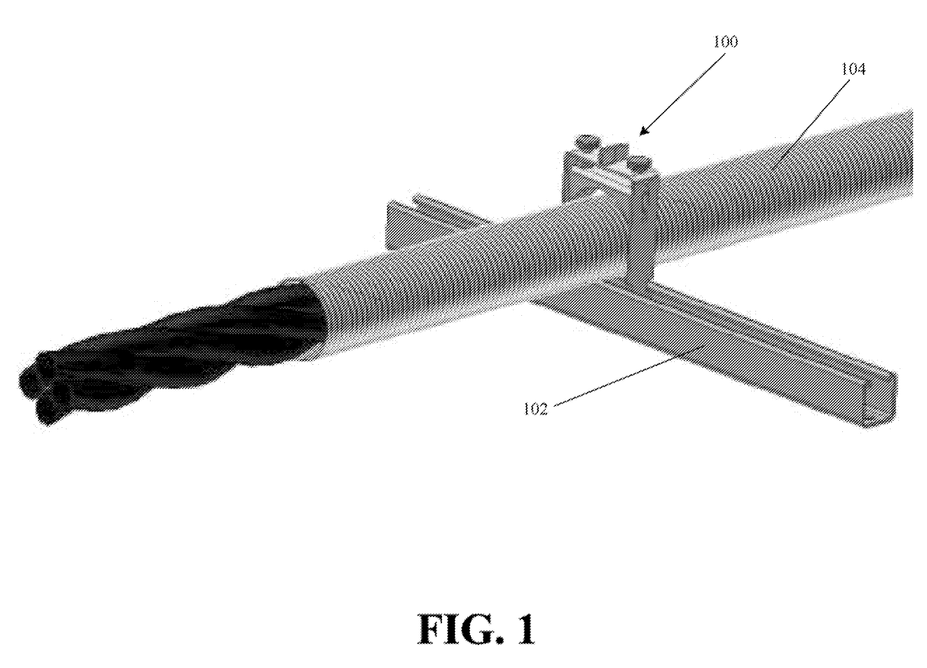

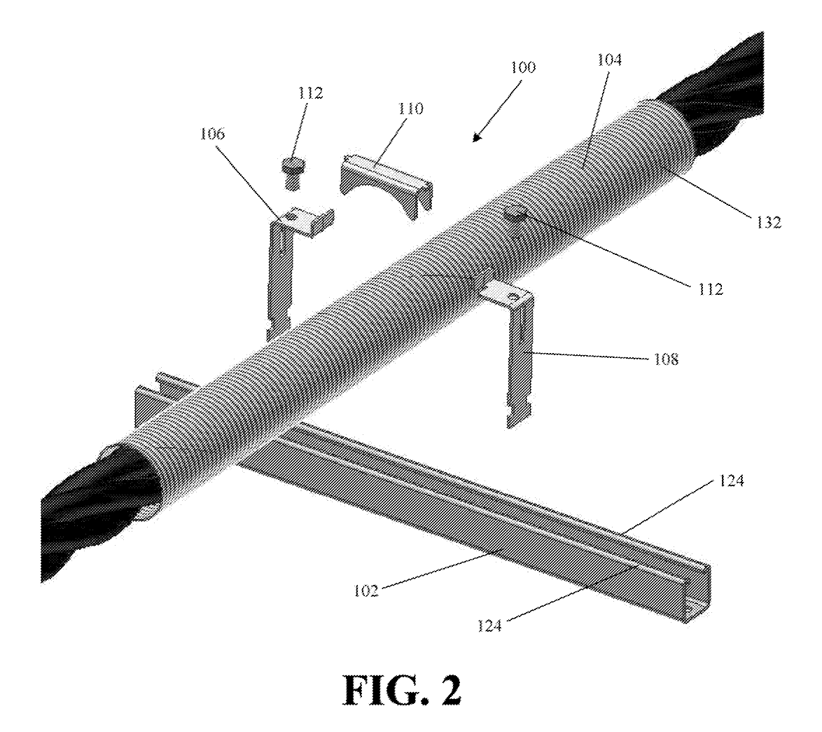

FIGS. 1 and 2 illustrate an example apparatus, such as a clamp, in accordance with an embodiment of the invention. As shown in FIG. 1, a clamp 100 can be mounted to an object, such as a strut 102, and a MC cable 104 can be mounted between the clamp 100 and strut 102 to maintain the relative position of the MC cable 104 against the strut 102. The orientation of the clamp 100, strut 102, and MC cable 104 can be any different combination. One example orientation of these components can be a substantially vertically-oriented MC cable 104, a substantially horizontal strut 102, and the clamp 100 maintaining the position of the MC cable 104 relative to the strut 102.

FIG. 2 illustrates an exploded view of the clamp 100 shown in FIG. 1. In this example, certain example component parts of the clamp 100 can be observed. For instance, the clamp 100 shown can include a clamp body including a first clamp body 106, a second clamp body 108, and a saddle portion 110; and at least one adjustment device 112, such as a pair of bolts or fasteners. Other component parts can be part of other systems, apparatus, or clamps in accordance with other embodiments of the invention.

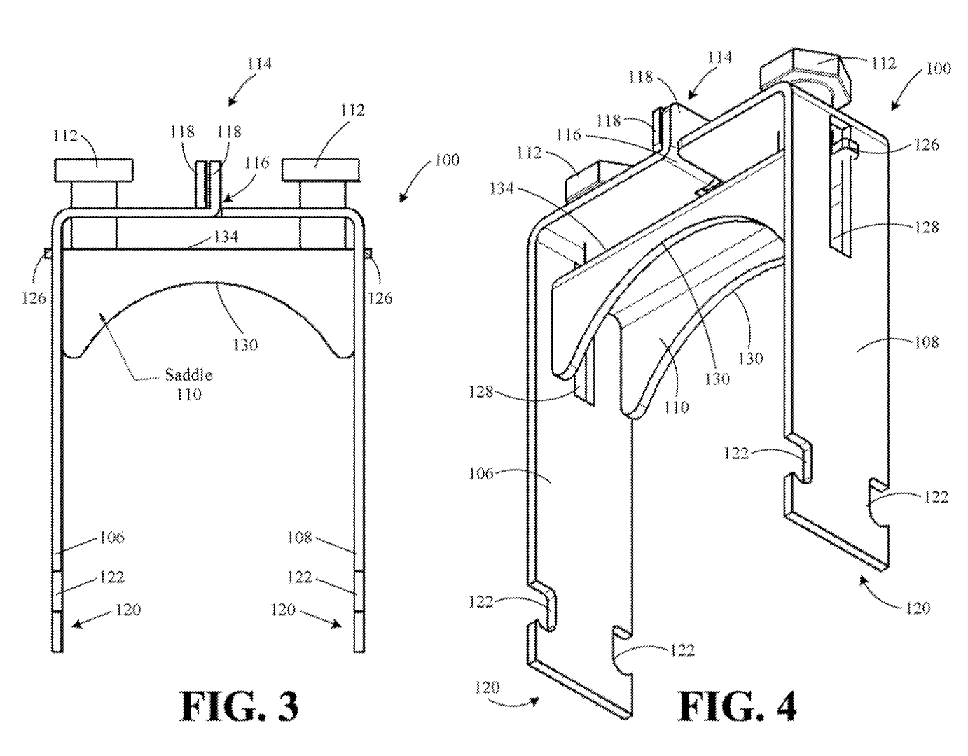

A front view of the clamp 100 is shown in FIG. 3, and a perspective view of the clamp 100 is shown in FIG. 4. In the embodiment shown in FIGS. 3-4, the first clamp body 106 and second clamp body 108 can be similarly shaped components and are configured to mount together or interlock at an initial end 114 of the first clamp body 106 and second clamp body 108. By way of example, each initial end 114 of the first clamp body 106 and second clamp body can include a slot 116 and a right-angle projection 118. When the first clamp body 106 and second clamp body 108 are mounted together, the right angle projection 118 of one clamp body fits within the slot of the 116 of the other clamp body, and vice-versa, such that in a mounted configuration, the right angle projections 118 of both the first clamp body 106 and second clamp body 108 are adjacent to each other as shown in FIGS. 3 and 4.

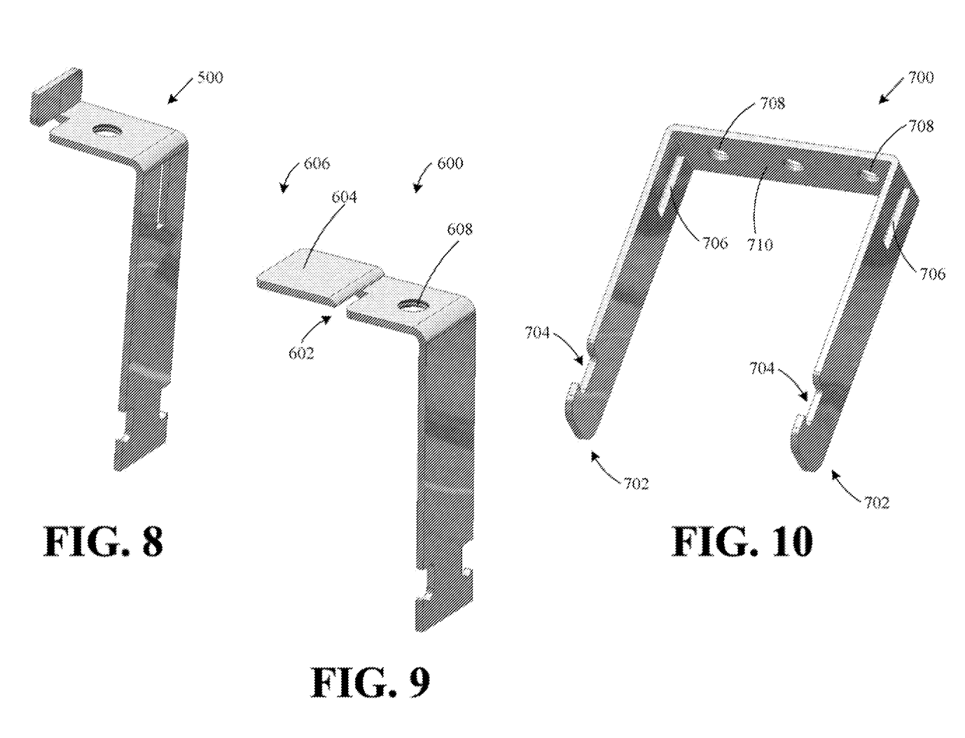

Both the first clamp body 106 and second clamp body 108 can be operable to mount to the strut 102 by way of a T-shaped opposing end 120 with a pair of notches 122, opposite of the upper end of the first clamp body 106 and second clamp body 108. The T-shaped opposing end 120 is configured to correspond with a portion of the strut 102, for example, a pair of inwardly curved, opposing, upper edges 124 of the strut 102 shown in FIG. 2, which in this example, can be a square U-shaped strut. Saddle portion 110 can be a square U-shaped component with end projections 126 configured to mount to corresponding lengthwise oriented slots 128 in the first clamp body 106 and second clamp body 108. When the T-shaped opposing end 120 is mounted to the upper edges 124 of the strut 102, the upper edges 124 of the strut engage the corresponding notches 122 of the T-shaped opposing end 120 of both the first clamp body 114 and second clamp body 116, thus maintaining the first clamp body 114 and second clamp body 116 in a relatively perpendicular orientation relative to the strut 102. An example component for a first clamp body 106 and a second clamp body 108 is shown in greater detail in FIG. 8. Other embodiments of a first clamp body and second clamp body, or structures having similar functionality are shown in greater detail in FIGS. 9 and 10.

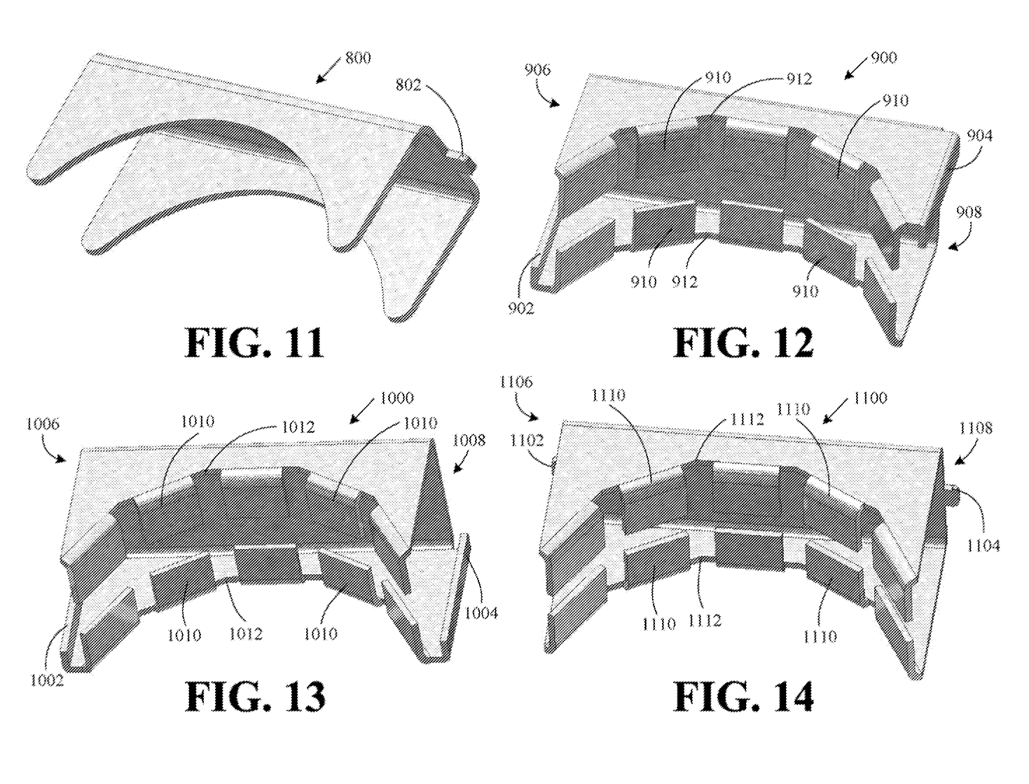

When the saddle portion 110 is positioned between the first clamp body 106 and second clamp body 108, the saddle portion 110 can move upward or downward with respect to the lengthwise oriented slots 128 in the first clamp body 106 and second clamp body 108. A pair of concave surfaces 130 of the saddle portion 110 can receive an outer surface 132 (shown in FIG. 2) of the MC cable 104 when the MC cable is threaded between the first clamp body 106 and second clamp body 108 mounted together or interlocked at the initial end 114, and between the saddle portion 110 and the upper edges 124 of the strut 102. An example component for a saddle portion is shown in greater detail in FIG. 11. Other embodiments of a saddle portion, or structures having similar functionality are shown in greater detail in FIGS. 12-14.

At least one adjustment device 112, such as a pair of bolts or fasteners, can be threaded through respective holes machined in the first clamp body 106 and second clamp body 108 and directed towards a relatively flat surface 134 of the saddle portion 110 opposite of the concave surfaces 130. At least one adjustment device 112 can be manually tightened or loosened as needed to increase or decrease an application of force on the saddle portion 110, causing the saddle portion 110 to move upward or downward with respect to the lengthwise oriented slots 128 in the first clamp body 106 and second clamp body 108, which in turn applies force on the outer surface 132 of the MC cable 104. In one embodiment, a suitable adjustment device can be a pair of ½″×13×2″ bolts.

In another embodiment, a suitable adjustment device can be any number of bolts or fasteners, such as one, three, or more. While a pair of bolts is shown in the illustrations and descriptions, one skilled in the art will recognize that a single bolt or fastener, or multiple bolts or fasteners, could be used to increase or decrease an application of force on the saddle portion 110 of FIG. 2, causing the saddle portion 110 to move upward or downward with respect to the first clamp body 106 and second clamp body 108, which in turn could apply force on the outer surface 132 of the MC cable 104.

In yet another embodiment, a suitable adjustment device can be a spring or spring type device that could be used to increase or decrease an application of force on the saddle portion 110 of FIG. 2, causing the saddle portion 110 to move upward or downward with respect to the first clamp body 106 and second clamp body 108, which in turn could apply force on the outer surface 132 of the MC cable 104.

In one aspect of an embodiment, the clamp substantially resists cable movement when a pullout force is applied to the cable.

In one aspect of an embodiment, the clamp body can include a first clamp body portion, a second clamp body portion, wherein the first clamp portion and second clamp body portion interlock with each other, and a saddle portion positioned between the first clamp body portion and the second clamp body portion, wherein the saddle portion is manipulated by the at least one adjustment device.

In one aspect of an embodiment, the at least one adjustment device can include at least one of the following: a bolt, a pair of bolts, or a spring. It will be recognized that a variety of devices and/or techniques can be used to manipulate a portion of a clamp body or saddle portion to apply force on the outer surface of a MC cable in accordance with embodiments of the invention.

In one aspect of an embodiment, an external portion of the clamp body is operable to conform with the portion of the cable.

In one aspect of an embodiment, the clamp body maintains the cable in a relatively vertical orientation with respect to the strut.

In one aspect of an embodiment, the first clamp body portion or the second clamp body portion is operable to engage a portion of the strut to maintain the position of the clamp body with respect to the universal strut.

In one aspect of an embodiment, the saddle portion comprises a plurality of plates or series of projections operable to contact the portion of the cable.

It will be recognized that systems, apparatus, and clamps in accordance with embodiments of the invention can be made with a variety of durable materials such as steel, aluminum, alloys, composites, and any combination thereof. It will be further recognized that material selection for compatibility with the application, the MC cable, and other clamp components can be controlled. It will be appreciated that while the specification describes certain shapes, configurations, and orientations of an example clamp with a first clamp body, a second clamp body, a saddle portion, and at least one adjustment device, there may, in certain other embodiments, be different shaped clamps with the same, similar, or different components having the same, similar, or different shapes, configurations and/or orientation without departing from example embodiments of the invention. Other system, apparatus, and clamp embodiments in accordance with the invention can include fewer or greater numbers of components and may incorporate some or all of the functionality described with respect to the system, apparatus, and clamp components shown in FIGS. 1-4.

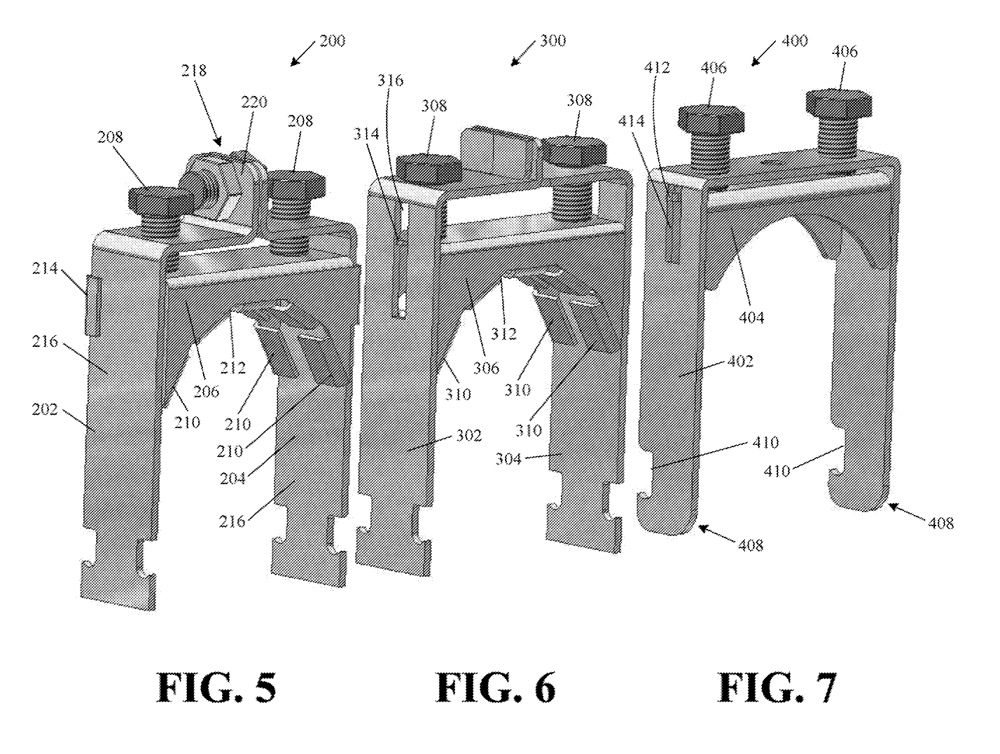

FIGS. 5-7 illustrate perspective views of other example systems, apparatus, and clamps according to certain embodiments of the invention. In FIG. 5, the clamp 200 shown includes a first clamp body 202, a second clamp body 204, a saddle portion 206, and at least one adjustment device 208. While similar in functionality to the example system, apparatus, and clamp shown in FIGS. 1-4, the clamp 200 shown in FIG. 5 includes other features and aspects. For example, the clamp 200 includes a series of projections 210 adjacent to the pair of concave surfaces 212 of the saddle portion 206. The projections 210 are approximate right angle projections from the concave surfaces 212 and increase the surface area contact between the saddle portion 206 and the external surface of a MC cable, such as 104 in FIG. 1, when the MC cable is clamped between the saddle portion 206 and an adjacent strut, such as 102 in FIG. 1. Furthermore, the saddle portion 206 includes an offset projection 214 at opposing ends that make substantial contact with the respective lengthwise sides 216 of the first clamp body 202 and second clamp body 204. When at least one adjustment device 208 is tightened or loosened, the offset projections 214 slide against the respective lengthwise sides 216 of the first clamp body 202 and second clamp body 204. In addition, the clamp 200 includes a fastener device, such as a bolt and nut combination 218, to mount or interlock the first clamp body 202 and second clamp body 204 together. In this embodiment, the first clamp body 202 and second clamp body 204 can be modified with a corresponding hole machined through the right angle projections 220, and the first clamp body 202 and second clamp body 204 can be substantially mounted or interlocked together when the bolt is inserted through the hole, and the nut is tightened onto the bolt.

FIG. 6 illustrates a perspective view of another example system, apparatus, and clamp according to a certain embodiment of the invention. In FIG. 6, the clamp 300 shown includes a first clamp body 302, a second clamp body 304, a saddle portion 306, and at least one adjustment device 308. While similar in functionality to the example system, apparatus, and clamp shown in FIGS. 1-4, the clamp 300 shown in FIG. 6 includes other features and aspects. For example, the clamp 300 includes a series of projections 310 adjacent to the pair of concave surfaces 312 of the saddle portion 306. The projections 310 are approximate right angle projections from the concave surfaces 312 to increase the surface area contact between the saddle portion 306 and the external surface of a MC cable, such as 104 in FIG. 1, when the MC cable is clamped between the saddle portion 306 and an adjacent strut, such as 102 in FIG. 1. Similar to the saddle portion 110 in FIGS. 3 and 4, the saddle portion 306 can be similarly positioned between a first clamp body 302 and second clamp body 304 with end projections 314 at opposing ends to mount to corresponding lengthwise oriented slots 316 in the first clamp body 302 and second clamp body 304.

FIG. 7 illustrates a perspective view of another example system, apparatus, and clamp according to a certain embodiment of the invention. In FIG. 7, the clamp 400 shown includes a unitary clamp body 402, a saddle portion 404, and at least one adjustment device 406. While similar in functionality to the example system, apparatus, and clamp shown in FIGS. 1-4, the clamp 400 shown in FIG. 7 includes other features and aspects. For example, the clamp 400 includes a unitary clamp body 402 which consolidates the structure of a first clamp body and second clamp body, shown in FIGS. 1-6, into a unitary square U-shape. Furthermore, the clamp 400 includes a J-shaped opposing end 408 with a single notches 410 on each leg of the unitary clamp body 402. The J-shaped opposing end 408 is configured to correspond with a portion of a strut or other corresponding structure for mounting a MC cable similar to 104 in FIG. 1. When the J-shaped opposing end 408 is mounted to an upper edge of a strut or other structure for mounting a MC cable, the upper edge of the strut or other structure for mounting a MC cable can engage the corresponding notches 410 of the J-shaped opposing end 408 of the unitary clamp body 402, thus maintaining the unitary clamp body 402 in a relatively perpendicular orientation relative to the strut or other structure for mounting a MC cable. Further, the saddle portion 404 can be positioned between the legs of the unitary clamp body 402 with end projections 412 at opposing ends to mount to corresponding lengthwise oriented slots 414 in the unitary clamp body 402. The unitary clamp body 402 is shown in greater detail in FIG. 10.

One skilled in the art may recognize the applicability of embodiments of the invention to other environments, contexts, and applications. One will appreciate that components of the systems, apparatus, and clamps shown in and described with respect to FIGS. 1-7 are provided by way of example only. Numerous other operating environments, systems, apparatus, and clamps are possible. Accordingly, embodiments of the invention should not be construed as being limited to any particular operating environment, system, apparatus, or clamp configuration.

FIGS. 8-10 illustrate certain components of example clamps in accordance with embodiments of the invention. FIGS. 8 and 9 each show an example first clamp body or a second clamp body. While only a single component is shown in each figure, each of the components shown typically operates with a similarly shaped, opposite component. For example, the clamp component 500 shown in FIG. 8 is similar to the second clamp body 108 in FIG. 1. The clamp component 500 can be mounted to or interlocked with a similarly shaped clamp component similar to the first clamp body 104 in FIG. 1. In this manner, the clamp component 500 can be used as the second clamp body 108 shown in FIGS. 1-4.

The clamp component 600 shown in FIG. 9 includes similar functionality to the clamp component 500 in FIG. 8, but has a different configuration. The clamp component 600 includes a slot 602 and relatively flat, offset projection 604 at an initial end 606. The offset projection 604 can be mounted to or interlocked with an opposing clamp component with a correspondingly shaped slot and offset projection to form a clamp body for a clamp in accordance with an embodiment of the invention. A hole 608 machined in the clamp component 600 can receive at least one adjustment device, such as a threaded bolt, and used similarly to the adjustment device shown as 112 in FIG. 1 to tighten to loosen the associated clamp.

In FIG. 10, a unitary clamp body 700 is shown similar to the unitary clamp body 402 shown in FIG. 7. In this view, the unitary clamp body 700 shown includes J-shaped opposing ends 702 with respective single notches 704 on each leg of the unitary clamp body 700, a pair of lengthwise slots 706 to receive end projections of a saddle portion, such as 404 in FIG. 7, and a series of holes 708 in the adjoining body piece 710 between the legs to receive at least one adjustment device, such as a threaded bolt or fastener similar to 406 in FIG. 7.

FIGS. 11-14 illustrate certain components of example saddle portions in accordance with embodiments of the invention. FIG. 11 shows an example saddle portion 800 for a clamp in accordance with an embodiment of the invention. The saddle portion 800 shown in similar to the saddle portion 110 shown in FIG. 1. The saddle portion 800 can be similarly positioned between a first clamp body, such as 106 in FIG. 1, and second clamp body, such as 108 in FIG. 1, with end projections 802 configured to mount to corresponding lengthwise oriented slots, such as 128 in FIG. 4, in the first clamp body 106 and second clamp body 108.

FIG. 12 shows an example saddle portion 900 for a clamp in accordance with an embodiment of the invention. The saddle portion 900 shown in similar to the saddle portion 206 shown in FIG. 5. The saddle portion 900 can be similarly positioned between a first clamp body, such as 202 in FIG. 5, and second clamp body, such as 204 in FIG. 5, with offset projections 902, 904 at opposing ends that make substantial contact with the respective lengthwise sides 216 of the first clamp body 202 and second clamp body 204. In this embodiment, the offset projections 902, 904 are also on opposing lateral faces 906, 908 of the saddle portion 900. When at least one adjustment device, such as 208 in FIG. 5, is tightened or loosened, the offset projections 902, 904 can slide against the respective lengthwise sides 216 of the first clamp body 202 and second clamp body 204. Furthermore, the saddle portion 900 shown includes a series of projections 910 or plates adjacent to the pair of concave surfaces 912 of the saddle portion 900. The projections 910 or plates are approximate right angle projections from the concave surfaces 912 and increase the surface area contact between the saddle portion 900 and the external surface of a MC cable, such as 104 in FIG. 1, when the MC cable is clamped between the saddle portion 900 and an adjacent strut, such as 102 in FIG. 1.

FIG. 13 shows an example saddle portion 1000 for a clamp in accordance with an embodiment of the invention. The saddle portion 1000 shown in similar to the saddle portion 206 shown in FIG. 5, but with the offset projections 1002, 1004 on the same lateral faces 1006, 1008 of the saddle portion 1000. Similar to the saddle portion 206 in FIG. 5, the saddle portion 900 can be similarly positioned between a first clamp body, such as 202 in FIG. 5, and second clamp body, such as 204 in FIG. 5, with offset projections 1002, 1004 at opposing ends 1006, 1008 that make substantial contact with the respective lengthwise sides 216 of the first clamp body 202 and second clamp body 204. When at least one adjustment device, such as 208 in FIG. 5, is tightened or loosened, the offset projections 1002, 1004 can slide against the respective lengthwise sides 216 of the first clamp body 202 and second clamp body 204. Furthermore, the saddle portion 1000 shown includes a series of projections 1010 or plates adjacent to the pair of concave surfaces 1012 of the saddle portion 1000. The projections 1010 or plates are approximate right angle projections from the concave surfaces 1012 and increase the surface area contact between the saddle portion 1000 and the external surface of a MC cable, such as 104 in FIG. 1, when the MC cable is clamped between the saddle portion 1000 and an adjacent strut, such as 102 in FIG. 1.

FIG. 14 shows an example saddle portion 1100 for a clamp in accordance with an embodiment of the invention. The saddle portion 1100 shown in similar to the saddle portion 306 shown in FIG. 6. Similar to the saddle portion 306 in FIG. 6, the saddle portion 1100 can be similarly positioned between a first clamp body, such as 302 in FIG. 6, and second clamp body, such as 304 in FIG. 6, with end projections 1102, 1104 at opposing ends 1106, 1108 to mount to corresponding lengthwise oriented slots, such as 314 in the first clamp body 302 and second clamp body 304 of FIG. 6. When at least one adjustment device, such as 308 in FIG. 6, is tightened or loosened, the offset projections 1102, 1104 can slide within the slots 314 of the first clamp body 302 and second clamp body 304. Furthermore, the saddle portion 1100 shown includes a series of projections 1110 or plates adjacent to the pair of concave surfaces 1112 of the saddle portion 1100. The projections 1110 or plates are approximate right angle projections from the concave surfaces 11012 and increase the surface area contact between the saddle portion 1100 and the external surface of a MC cable, such as 104 in FIG. 1, when the MC cable is clamped between the saddle portion 1000 and an adjacent strut, such as 102 in FIG. 1.

One skilled in the art may recognize the applicability of these clamp components in certain embodiments of the invention to other environments, contexts, and applications. One will appreciate that the clamp components shown in and described with respect to FIGS. 8-14 are provided by way of example only. Numerous other operating environments, systems, apparatus, and clamps are possible using these or similar clamp components. Accordingly, these clamp components should not be construed as being limited to any particular operating environment, system, apparatus, or clamp configuration.

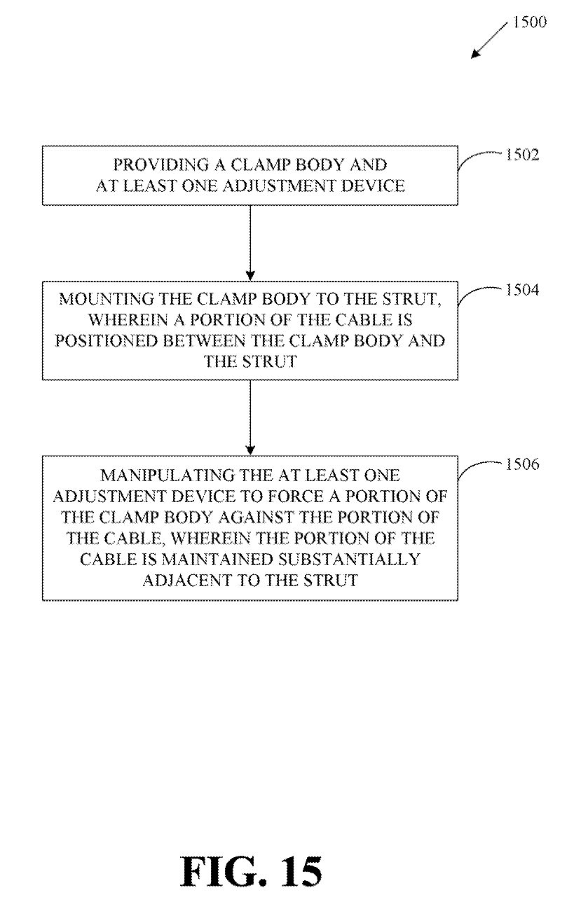

Example methods and processes which can be implemented with the example systems, apparatus, clamps, and clamp components of FIGS. 1-14 are described by reference to FIG. 15. FIG. 15 illustrates a flowchart of an example method according to one embodiment of the invention.

The method 1500 begins at block 1502, wherein a clamp body and at least one adjustment device are provided. In the embodiment shown in FIG. 15, at least one clamp body similar to the first clamp body 106, second clamp body 108, and saddle portion 110 in FIG. 1, and at least one adjustment device, such as 112 in FIG. 1, can be provided.

In one aspect of an embodiment, the clamp body can include a first clamp body portion; a second clamp body portion, wherein the first clamp portion and second clamp body portion interlock with each other; and a saddle portion positioned between the first clamp portion and second clamp portion, wherein the saddle portion is manipulated by the at least one adjustment device.

In one aspect of an embodiment, at least one adjustment device can include at least one of the following: a bolt, a pair of bolts, or a spring.

Block 1502 is followed by block 1504, in which the clamp body is mounted to a strut, wherein a portion of a cable is positioned between the clamp body and the strut. In the embodiment shown in FIG. 15, the clamp body such as the first clamp body 106 and second clamp body 108 of FIG. 1 can be mounted to a strut, such as 102 in FIG. 1. Further, a portion of a cable, such as a MC cable 104, can be positioned between the clamp body and the strut.

In one aspect of an embodiment, an external portion of the clamp body is operable to conform with a portion of a cable.

Block 1504 is followed by block 1506, in which the at least one adjustment device can be manipulated to force a portion of the clamp body against the portion of the cable, wherein the portion of the cable is maintained substantially adjacent to the strut. In the embodiment shown in FIG. 15, the at least one adjustment device, such as 112 in FIG. 1, can be manipulated to force the saddle portion 110 against an external surface of the MC cable 104. In this manner, the position of the MC cable 104 can be maintained substantially adjacent to the strut 102.

In one aspect of an embodiment, the clamp body maintains the cable in a relatively vertical orientation with respect to the strut.

In one aspect of an embodiment, the first clamp body portion or the second clamp body portion is operable to engage a portion of the strut to maintain the position of the clamp body with respect to the strut.

After block 1506, the method 1500 ends.

Additionally, it is to be recognized that, while the invention has been described above in terms of one or more embodiments, it is not limited thereto. Various features and aspects of the above described invention may be used individually or jointly. Although the invention has been described in the context of its implementation in certain environments and for certain purposes, its usefulness is not limited thereto and the invention can be beneficially utilized in any number of environments and implementations. Furthermore, while the methods have been described as occurring in a specific sequence, it is appreciated that the order of performing the methods is not limited to that illustrated and described herein, and that not every element described and illustrated need be performed. Accordingly, the claims set forth below should be construed in view of the full breadth of the embodiments as disclosed herein.

The claimed invention is:

1. A clamp for mounting a cable to a strut, the clamp comprising:
a clamp body operable to mount to the strut, wherein a portion of the cable is positioned between the clamp body and the strut; and
at least one adjustment device operable to force a portion of the clamp body against the portion of the cable, wherein the portion of the cable is maintained substantially adjacent to the strut.

2. The clamp of claim 1, wherein the clamp substantially resists cable movement when a pullout force is applied to the cable.

3. The clamp of claim 1, wherein the clamp body comprises:
a first clamp body portion;
a second clamp body portion, wherein the first clamp portion and second clamp body portion interlock with each other; and
a saddle portion positioned between the first clamp body portion and the second clamp body portion, wherein the saddle portion is manipulated by the at least one adjustment device.

4. The clamp of claim 1, wherein the at least one adjustment device comprises at least one of the following: a bolt, a pair of bolts, or a spring.

5. The clamp of claim 1, wherein an external portion of the clamp body is operable to conform with the portion of the cable.

6. The clamp of claim 1, wherein the clamp body maintains the cable in a relatively vertical orientation with respect to the strut.

7. The clamp of claim 3, wherein the first clamp body portion or the second clamp body portion is operable to engage a portion of the strut to maintain the position of the clamp body with respect to the universal strut.

8. The clamp of claim 3, wherein the saddle portion comprises a plurality of plates operable to contact the portion of the cable.

9. A method for mounting a cable to a strut, the method comprising:
providing a clamp body and at least one adjustment device;
mounting the clamp body to the strut, wherein a portion of the cable is positioned between the clamp body and the strut; and
manipulating the at least one adjustment device to force a portion of the clamp body against the portion of the cable, wherein the portion of the cable is maintained substantially adjacent to the strut.

10. The method of claim 9, wherein the clamp body comprises:
a first clamp body portion;
a second clamp body portion, wherein the first clamp portion and second clamp body portion interlock with each other; and
a saddle portion positioned between the first clamp portion and second clamp portion, wherein the saddle portion is manipulated by the at least one adjustment device.

11. The method of claim 9, wherein the at least one adjustment device comprises at least one of the following: a bolt, a pair of bolts, or a spring.

12. The method of claim 9, wherein an external portion of the clamp body is operable to conform with the portion of the cable.

13. The method of claim 9, wherein the clamp body maintains the cable in a relatively vertical orientation with respect to the strut.

14. The method of claim 9, wherein the first clamp body portion or the second clamp body portion is operable to engage a portion of the strut to maintain the position of the clamp body with respect to the strut.

15. A system for mounting a cable to a strut, the system comprising:
a first clamp body portion;
a second clamp body portion, wherein the first clamp portion and second clamp body portion interlock with each other defining a clamp body operable to mount to the strut, wherein a portion of the cable is positioned between the clamp body and the strut;
a saddle portion mounted between the first clamp body portion and the second clamp body portion; and
at least one adjustment device operable to force the saddle portion against the portion of the cable, wherein the portion of the cable is maintained substantially adjacent to the strut between the saddle portion and the strut.

16. The system of claim 15, wherein the saddle portion substantially resists cable movement when a pullout force is applied to the cable.

17. The system of claim 15, wherein the at least one adjustment device comprises at least one of the following: a bolt, a pair of bolts, or a spring.

18. The system of claim 15, wherein an external portion of the saddle portion is operable to conform with the portion of the cable.

19. The system of claim 15, wherein the clamp body maintains the cable in a relatively vertical orientation with respect to the universal strut.

20. The system of claim 15, wherein the first clamp body portion or the second clamp body portion is operable to engage a portion of the strut to maintain the position of the clamp body with respect to the strut.
